(19) United States
(12) Patent Application Publication
(10) Pub. No.: US 2002/0056361 A1
(43) Pub. Date: May 16, 2002

(54) Vacuum servo unit

(76) Inventors: Akihiko Miwa, Anjo-shi (JP); Kaoru Tsubouchi, Toyota-shi (JP); Tetsuaki Tsuzuki, Gamagori-shi (JP)

Correspondence Address: Platon N. Mandros, Esquire, BURNS, DOANE, SWECKER & MATHIS, L.L.P., P.O. Box 1404, Alexandria, VA, 22313-1404, US

(21) Appl. No.: 09/984,211

(22) Filed: Oct. 29, 2001

(30) Foreign Application Priority Data
Oct. 27, 2000 (JP) 2000-329154

(51) Int. Cl. F15B 9/10

(52) U.S. Cl. 91/367; 91/376 R

(57) ABSTRACT

A vacuum servo unit includes a constant pressure chamber and a variable pressure chamber in a housing, a power piston, an output member, an input member, a plunger, a valve mechanism, and an actuator. The actuator is disposed in the power piston for moving the plunger in the forward and rearward directions. The outer periphery of the actuator is provided with a concave or recessed portion serving as a communicating passage between the constant pressure chamber and the variable pressure chamber. The concave or recessed portion is in the form of a notch defined in a yoke enclosing the solenoid coil of the actuator. The communicating passage is constituted by the notch and the inner periphery of a cylindrical portion of the power piston at the front side of the power piston.

This application is based on and claims priority under 35 U.S.C. §119 with respect to Japanese Patent Application 2000-329154 filed on Oct. 27, the entire content of which is incorporated herein by reference

### FIELD OF THE INVENTION

This invention generally relates to a vacuum servo unit. More particularly, the present invention pertains to a vacuum servo unit applied to an automobile.

### BACKGROUND OF THE INVENTION

A known vacuum servo unit is disclosed in a Japanese Patent Application published as Toku-Kai 2000-177578. The disclosed vacuum servo unit is provided with a housing, a movable wall, a power piston fixed to the movable wall, an output member, an input member, a plunger, a valve mechanism and an actuator. The movable wall divides the inner space of the housing into a constant pressure chamber and a variable pressure chamber. The constant pressure chamber communicates with a negative pressure source, while the variable pressure chamber selectively communicates with the negative pressure source or atmospheric air. The output member output a forwardly directed force of the power piston corresponding to the movement of the movable wall. The input member is movable back and forth relative to the power piston in response to operation of a brake-operating member. The plunger is movable back and forth relative to the input member and is on the other hand movable back and forth with the input member corresponding to the movement of the input member. The valve mechanism serves for establishing/interrupting communication between the variable pressure chamber and atmospheric air and for establishing/interrupting communication between the constant pressure chamber and the variable pressure chamber. The actuator is accommodated in the power piston and activates the plunger to move back and forth.

According to the above-described vacuum servo unit, the actuator operated by a controller activates the plunger forming the valve mechanism, wherein a self-braking operation or an automatic braking operation is performed to generate a braking force independent of operation of a brake operating member (e.g., brake pedal) by a driver.

The actuator is formed as a solenoid. Generally speaking, these solenoids must be designed so as to ensure sufficient driving force to activate the plunger and must be able to restrain heat generation of the solenoid when the solenoid has been activated successively. To achieve the above-described purposes, the solenoids need to include a volume which is a particular volume or larger than such volume. However, the respective radial lengths or dimensions of the movable wall and the housing need to be enlarged to compensate for a decrease in the differential pressure receiving area. Therefore, the vacuum servo unit provided with an actuator can generate an output force that is substantially equivalent to the output force generated by a vacuum servo unit which is not provided with an actuator. In this case, the vacuum servo unit may need to be enlarged and this may make it difficult to accommodate the unit on a vehicle.

Alternatively, solenoids can be enlarged in the axial direction, maintaining the same driving force and the same volume of the actuator, instead of enlarging the solenoids in the radial direction. However, enlarging or increasing the axial length of the solenoid increases the axial length of the vacuum servo unit, thus still making it difficult to accommodate the unit on the vehicle.

It is thus seen that known vacuum servo units are susceptible of certain improvements with respect to reducing the size of the vacuum servo unit provided with an actuator.

### SUMMARY OF THE INVENTION

According to one aspect of the invention, a vacuum servo unit includes a housing, a movable wall dividing an inner space of the housing into a constant pressure chamber and a variable pressure chamber, with the constant pressure chamber communicating with a negative pressure source and the variable pressure chamber selectively communicating with the negative pressure source or the atmosphere. A power piston is connected to the movable wall, an output member outputs a forward moving force of the power piston in response to the movement of the movable wall, and an input member is disposed in the power piston and is movable in the forward and rearward directions relative to the power piston by an input force of a brake operating member. A plunger is movable back and forth relative to the input member and is movable back and force in response to the movement of the input member. A valve mechanism serves for establishing or interrupting communication between the variable pressure chamber and the atmosphere corresponding to the movement of the plunger and for establishing or interrupting communication between the constant pressure chamber and the variable pressure chamber. An actuator is disposed in the power piston for moving the plunger in the forward and rearward directions. The actuator is provided with a concave portion or recessed portion defined at the outer periphery of the actuator that serves as a communicating passage between the constant pressure chamber and the variable pressure chamber. The concave or recessed portion is a notch defined in a yoke enclosing the solenoid coil of the actuator. The communicating passage is formed by the notch and an inner periphery of a cylindrical portion at a front side of the power piston and the notch.

In accordance with another aspect of the invention, a vacuum servo unit includes a housing, a movable wall dividing an inner space of the housing into a constant pressure chamber communicating with a negative pressure source and a variable pressure chamber selectively communicating with the negative pressure source or atmosphere, a power piston connected to the movable wall, an output member for outputting a forward moving force of the power piston in response to the movement the movable wall, an input member disposed in the power piston and movable in the forward and rearward directions relative to the power piston by operation of a brake operating member, a plunger movable back and forth relative to the input member and being movable back and force in response to the movement of the input member, and a valve mechanism for establishing or interrupting communication between the variable pressure chamber and the atmosphere corresponding to the movement of the plunger and for establishing or interrupting communication between the constant pressure chamber and the variable pressure chamber. An actuator is disposed in the power piston for moving the plunger in the forward and rearward directions, with the actuator including a yoke. A lead wire electrically connects the actuator with an electronic control unit, and a notch is defined at the outer periphery of the yoke. A connecting portion between the lead wire and the actuator is disposed in the notch.

In accordance with an additional aspect of the invention, a vacuum servo unit includes a housing, a movable wall dividing an inner space of the housing into a constant pressure chamber communicating with a negative pressure source and a variable pressure chamber selectively communicating with the negative pressure source or atmosphere, a power piston connected to the movable wall, an output member for outputting a forward moving force of the power piston in response to movement the movable wall, an input member disposed in the power piston and movable in forward and rearward directions relative to the power piston by operation of a brake operating member, a plunger movable in the forward and rearward directions relative to the input member and being movable in the forward and rearward directions in response to movement of the input member, and a valve mechanism for establishing or interrupting communication between the variable pressure chamber and atmosphere corresponding to movement of the plunger and for establishing or interrupting communication between the constant pressure chamber and the variable pressure chamber. A solenoid coil, a magnetic movable core and a magnetic yoke are disposed in the power piston, with the movable core being moved in response to energization of the solenoid coil and being operatively connected to the plunger to move the plunger in forward and rearward directions upon energization of the solenoid coil. The magnetic yoke has an outer periphery provided with at least one notch forming part of a passage communicating the constant pressure chamber and the variable pressure chamber.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a cross-sectional view illustrating a vacuum servo unit according to a first embodiment of the present invention.

FIG. 2(a) is an enlarged front view of the yoke forming a part of the actuator in the vacuum servo unit illustrated in FIG. 1.

FIG. 2(b) is a side view of the yoke shown in FIG. 2(a).

FIG. 3 is a cross-sectional view illustrating a vacuum servo unit according to a second embodiment of the present invention.

### DETAILED DESCRIPTION OF THE INVENTION

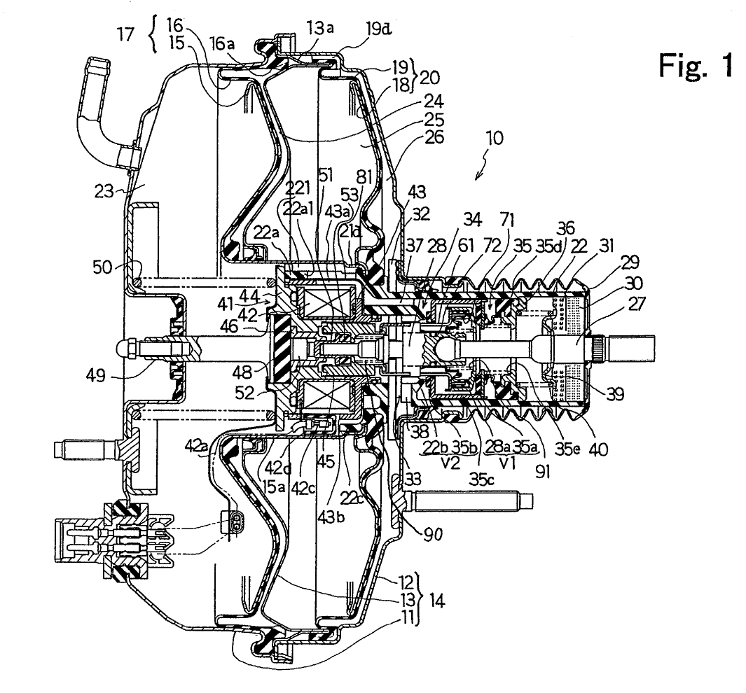

As shown in FIG. 1, a vacuum servo unit 10 includes a housing 14 having a front shell 11, a rear shell 12 and a dividing member 13 disposed between the front shell 11 and the rear shell 12. In the illustrated version of this embodiment of the present invention, the vacuum servo unit is a tandem type vacuum servo unit. A front side pressure chamber and a rear side pressure chamber are thus defined in the housing 14. A front side movable wall 17 is disposed in the front side pressure chamber and is movable back and forth (in the left and right directions in FIG. 1), while a rear side movable wall 20 is disposed in the rear side pressure chamber and is also movable back and forth.

The front side pressure chamber is divided into a first constant pressure chamber 23 and a first variable pressure chamber 24, while the rear side pressure chamber is divided into a second constant pressure chamber 25 and a second variable pressure chamber 26. The first constant pressure chamber 23 communicates with an engine intake manifold serving as a negative pressure source so as to be always maintained at a negative pressure when the engine unit is actuated. The second constant pressure chamber 25 communicates with the first constant pressure chamber 23 via a hole 21a and a groove 221 so as to be always maintained at the negative pressure when the engine unit is actuated. The first variable pressure chamber 24 communicates with the second variable pressure chamber 26 via a groove 16a, a hole 13a, and a groove 19a.

The vacuum servo unit 10 further includes a power piston 22 in which an input rod 27 is disposed. The input rod 27 is movable back and forth relative to the power piston 22. The front end portion of the input rod 27 is engaged with an input member 28 via a ball joint connection and the rear portion of the input rod 27 is engaged with a brake pedal. An air filter 30 and a noise-absorbing member 31 are disposed in a rear opening portion of the power piston 22. The inner space of the power piston 22 is thus exposed to atmospheric pressure via the noise-absorbing member 31 and the air filter 30.

The input member 28 is disposed in the front side (i.e., the left side in FIG. 1) of the power piston 22. A cup-like first transmitting member 51 is disposed at the front end of the input member 28. A second transmitting member 52 is disposed ahead of the first transmitting member 51. A reaction disc 48 is disposed ahead of the second transmitting member 52 and is adapted to come in contact with the front surface of the second transmitting member 52. The second transmitting member 52 is disposed in an inner hole of a guiding member 46 mounted at a stationary core 44 of a solenoid 41, the details of which will be described below. When the vacuum servo unit 10 is not activated, a predetermined clearance is defined between the second transmitting member 52 and the reaction disc 48.

The rear end of a substantially cylindrical plunger 61 is provided with an air valve seat 28a. The plunger 61 is coaxially disposed with the input member 28 at its outer periphery and is movable back and forth relative to the input member 28. A diaphragm 71 is disposed between the outer periphery of the input member 28 and an inner periphery of the plunger 61 for hermetically sealing a space between the input member 28 and the plunger 61. A key member 32 is disposed in the power piston 22 for regulating or defining the front movement limit and the rear movement limit movement of the input member 28 relative to the power piston 22. The key member 32 is inserted or positioned in a hole 33 radially defined in the power piston 22 and is engaged with the power piston 22 so that the key member 32 does not fall from the power piston 22.

A valve mechanism 34 is disposed in the power piston 22 and is changed over depending on the axial movement of the input member 28 relative to the power piston 22 so as to establish three conditions in the power piston 22. The valve mechanism 34 is adapted for connecting the second variable pressure chamber 26 with the first constant pressure chamber 23 and separating the second variable pressure chamber 26 from an atmosphere, wherein an output force from the power piston 22 is decreased (an output force decreasing condition). The valve mechanism 34 is also adapted to separate the second variable pressure chamber 26 from the first constant pressure chamber 23 and the atmosphere, wherein the output force from the power piston 22 is maintained (an output force maintaining condition). The valve mechanism 34 is further adapted to separate the second variable pressure chamber 26 from the first constant pressure chamber 23 while also connecting the second variable pressure chamber 26 with the atmosphere, wherein the output force from the power piston 22 is increased (an output force increasing condition).

The valve mechanism 34 includes the air valve seat 28a integrally formed with the plunger 61, a negative pressure valve seat 22b integrally formed with the power piston 22, an atmospheric pressure sealing portion 35a, and a negative pressure sealing portion 35b, which are all included as a unit in a control valve 35. Both the air valve seat 28a and the negative pressure valve seat 22b are in the form of a substantially ring-shaped or annular structure and face in the rearward director (i.e., to the right in FIG. 1). The atmospheric pressure sealing portion 35a opposes the air valve seat 28a and can be either in contact with the air valve seat 28a or separated from the air valve seat 28a. The negative pressure sealing portion 35b opposes the negative pressure valve seat 22b and can be either in contact with the negative pressure valve seat 22b or separated from the negative pressure valve seat 22b.

Principal components of the control valve 35 include a movable portion 35c, a stationary portion 35d, and a valve spring 35e. The movable portion 35c includes an integral structure of the atmospheric pressure sealing portion 35a and the negative pressure sealing portion 35b. The stationary portion 35d is hermetically fixed to the power piston 22 by a spring retainer 36. The valve spring 35e serves to push the movable member 35c in the forward direction.

An atmospheric pressure valve V1 is formed by the atmospheric pressure sealing portion 35a and the air valve seat 28a. A negative pressure valve V2 is formed by the negative pressure sealing portion 35b and the negative pressure valve seat 22b. A vacuum passage 37 is defined in the power piston 22 for connecting the negative pressure valve V2 of the valve mechanism 34 with the first constant pressure chamber 23. An air passage 38 is defined in the power piston 22 for connecting the atmospheric pressure valve V1 of the valve mechanism 34 with the second variable pressure chamber 26. The inner space of the stationary portion 35d is in communication with the atmosphere via the noise-absorbing member 31, the air filter 30, and the rear opening portion of the power piston 22.

When the air valve seat 28a of the atmospheric pressure valve V1 is in contact with the atmospheric pressure sealing portion 35a, the communication between the second variable pressure chamber 26 and the atmosphere is interrupted. On the other hand, when the air valve seat 28a is separated from the atmospheric pressure sealing portion 35a, the communication between the second variable pressure chamber 26 and the atmosphere is established. When the negative pressure valve seat 22b is in contact with the negative pressure sealing portion 35b, the communication between the first constant pressure chamber 23 and the second variable pressure chamber 26 is interrupted. On the other hand, when the negative pressure valves seat 22b is separated from the negative pressure sealing portion 35b, the communication between the first constant pressure chamber 23 and the second variable pressure chamber 26 is established.

A return spring 40 is disposed between the spring retainer 36 and another spring retainer 39 engaged with the input rod 27. The return spring 40 serves to push the input rod 27 and the input member 28 in the rearward direction. Accordingly, as shown in FIG. 1 which illustrates an initial stage of the unit when the brake pedal is not depressed, the air valve seat 28a is in contact with the atmospheric pressure sealing portion 35a. Meanwhile, the negative pressure sealing portion 35b is separated from the negative pressure valve seat 22b.

An actuator in the form of a solenoid 41 is accommodated in a cylindrical portion 22a of the power piston 22 at a front side of the power piston 22. The solenoid 41 includes a solenoid coil 42, a magnetic yoke 43, a magnetic stationary core 44, and a magnetic movable core 45.

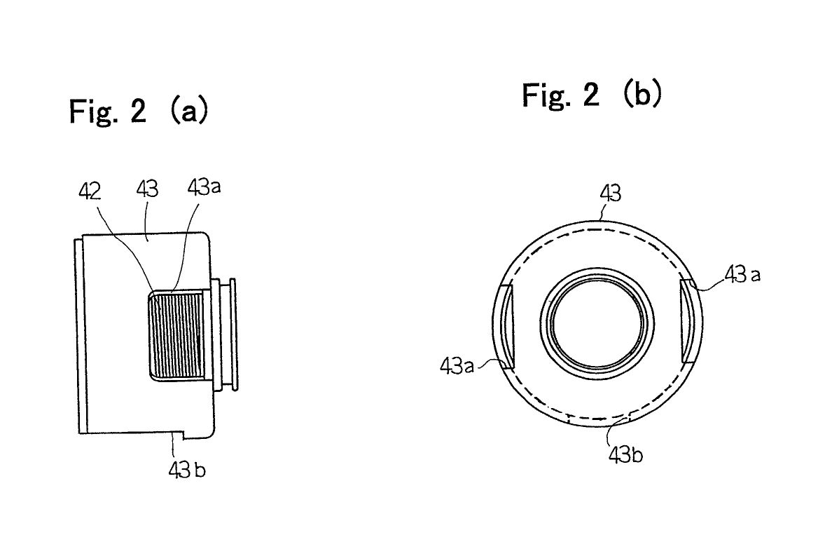

As shown in FIGS. 1, 2(a) and 2(b), a notch (i.e., a recessed or concave portion) 43a is defined at two circumferentially spaced apart portions from the outer periphery of the yoke 43 to the rear end surface of the yoke 43. The notches form a pair of first notches. A through hole 22a1 is defined in the cylindrical portion 22a at a position corresponding to the notch 43a. A communicating passage 81 is defined via the notch 43a, the through hole 22a1, and a vacuum passage 37 for connecting the first constant pressure chamber 23 with the second variable pressure chamber 26.

As described above, according to the structure of the vacuum servo unit 10 including the communicating passage 81 defined by the notch 43a and the through hole 22a1, there is no need to define an axially extending communicating passage integrally with the cylindrical portion 22a for connecting a constant pressure chamber with a variable pressure chamber. Therefore, the solenoid 41 can be accommodated in the power piston 22a with no need to enlarge the radial length or dimension of the cylindrical portion 22a of the power piston 22.

Further, both radial lengths or dimensions of a front side plate 15 and a rear side cylindrical portion 15a of the front side movable wall 17 are inhibited from being enlarged, whereby a differential pressure receiving area of the front side movable wall 17 is prevented from being reduced. That is, the vacuum servo unit 10 provided with the solenoid 41 as the actuator according to the first embodiment of the present invention can minimize an increase of the radial length of the movable wall and the housing, and can obtain a differential pressure receiving area and an output that are equivalent to the differential pressure receiving area and the output of a vacuum servo unit which is not provided with the actuator. Therefore, the vacuum servo unit 10 including a self-braking operation or an automatic braking operation can be supplied under a condition that the radial length or dimension of the vacuum servo unit 10 is substantially equivalent to the radial length of a vacuum servo unit which does not includes the self-braking operation or the automatic braking operation.

A notch 43b (second notch) for wiring is defined at the outer periphery of the yoke 43 and at a position spaced 90° from the notches 43a. A groove 22c for wiring is defined at the cylindrical portion 22a of the power piston 22 at a position corresponding to the notch 43b for wiring. A lead wire 42a and a terminal portion 42c are covered with an electrical insulator 42d and are fixed to the notch 43b for wiring and the groove 22c for wiring. Under the above-described structure, the terminal portion 42c is adjacent to the solenoid coil 42. Therefore, the radial length or dimension of the rear side cylindrical portion 15a of the front side movable wall 17 is prevented from being enlarged, and the differential pressure receiving area of the front side movable wall 17 is prevented from being reduced. That is, the vacuum servo unit 10 according to the first embodiment of the present invention can be prevented from being enlarged.

The movable core 45 is disposed at the outer periphery of the input member 28 and is axially movable back and forth (i.e., in the right-left direction in FIG. 1) relative to the power piston 22 and the input member 28. The movable core 45 is in the form of a substantially cylindrical unit provided with a radially inwardly directed flange portion at the intermediate or middle portion of the movable core 45. The movable core 45 is further provided with a radially outwardly directed flange portion at a rear end portion of the movable core 45.

A rubber made third transmitting member 53 is disposed between the movable core 45 and the first transmitting member 51. The third transmitting member 53 serves to transmit a forward moving force of the movable core 45 to the first transmitting member 51 and to transmit a return force of the forward moving force to the movable core 45.

The rear outwardly directed flange portion of the movable core 45 is engaged with an inward flange portion formed at a front edge portion of the plunger 61. A return spring 90 is disposed between a rear surface of the inward flange portion of the movable core 45 and a front surface of the front outward flange portion of the input member 28. The return spring 90 applies a biasing force pushing or urging the movable core 45 relative to the plunger 61 in the forward direction.

A valve spring 91 is disposed between a spring retainer fixed to the input member 28 for supporting the diaphragm 71 and an inward flange portion formed at a rear end portion of the plunger 61. The valve spring 91 applies a biasing force to push or urge the plunger 61 in the rearward direction. The rearward biasing force of the valve spring 91 moves the valve mechanism 34 in the rearward direction against the biasing force of the return spring 90 and the valve spring 35e, and opens the negative pressure valve V2. Therefore, the movable core 45 is movable back and forth integrally with the input member 28 relative to the power piston 22. When the solenoid 41 is energized, (i.e., when the actuator is active), the movable core 45 is moved in the forward direction by the stationary core 44 against the biasing force of the valve spring 91 relative to the input member 28.

The solenoid coil 42 is accommodated at the outer periphery of the movable core 45. The solenoid coil 42, the yoke 43, and the stationary core 44 are fixed with the power piston 22. The solenoid coil 42 is electrically connected to an electronic control unit (not shown) by a lead wire 42a. The electronic control unit is located outside the housing 14. When the solenoid coil 42 is de-energized (i.e., when the actuator is inactive), a predetermined clearance is defined between the front end surface of the movable core 45 and the stationary core 44. When the solenoid coil 42 is energized (i.e., when the actuator is active), an electromagnetic attraction force is generated between the stationary core 44 and the movable core 45. Therefore, the movable core 45 is moved in the forward direction by virtue of the electromagnetic attraction force.

The rubber made reaction disc 48 is disposed in a large diameter portion of a stepped hole defined at the front end surface of the stationary core 44. An output rod 49 serving as an output member is hermetically and axially movably inserted into the center portion of the front shell 11 of the housing 14. The rear end portion of the output rod 49 is slidably disposed in the large diameter portion of the stepped hole of the stationary core 44. The output rod 49 is functionally connected to a master cylinder piston.

As is commonly known, the reaction disc 48 transfers the forward force of the power piston 22 and the input member 28 to the output rod 49. The reaction disc 38 further applies a reaction force relative to the output force from the output rod 49 to the input member 28 for biasing the input member 28 in the rearward direction. Under the aforementioned initial stage, the predetermined clearance is defined between the rear surface of the reaction disc 48 and the front edge surface of the second input member 52. A return spring 50 is disposed at the center portion of the first constant pressure chamber 23 for biasing the power piston 22 and the movable walls 17, 20 in the rearward direction relative to the housing 14.

A normal braking operation according to the first embodiment of the present invention is described below with the solenoid (i.e., the actuator) 41 being inactive. When the brake pedal is depressed to carry out the normal braking operation by a driver, the input rod 27 is moved in the forward direction relative to the power piston 22. Accordingly, the input member 28 is moved forward integrally with the input rod 27. Corresponding to the forward movement of the input member 28, the plunger 61 is moved forward integrally with the input member 28. That is, the input rod 27, the input member 28, the plunger 61, the movable core 45, the third transmitting member 53 and the first transmitting member 52 are moved forward as a unit relative to the power piston 22.

Corresponding to the forward movement of the input member 28, the movable portion 35c of the control valve 35 is biased in the forward direction integrally with the input member 28 by virtue of the valve spring 35e. The negative pressure sealing portion 35b of the control valve 35 comes in contact with the negative pressure valve seat 22b of the power piston 22, whereby the negative pressure valve V2 is closed. The closing operation of the negative pressure valve V2 interrupts the communication between the vacuum passage 37 and the air passage 38, whereby the communication between the second variable pressure chamber 26 and the first constant pressure chamber 23 is interrupted. That is, the valve mechanism 34 is changed over from the output force decreasing condition to the output force maintaining condition.

From the output force maintaining condition of the valve mechanism 34, the input member 28 is further moved forward, wherein the air valve seat 28a of the input member 28 is separated from the atmospheric sealing portion 35a of the control valve 35 by a predetermined distance. Therefore, the air valve V1 is opened. By virtue of the opening operation of the air valve V1, the air communication between the air passage 38 and the atmosphere is established via the clearance between the air pressure valve seat 28a and the atmospheric sealing portion 35a, the inner space of the stationary portion 35d, the noise-absorbing member 31, the air filter 30, and the rear opening portion of the power piston 22. Therefore, the second variable pressure chamber 26 is communicated with the atmosphere, whereby the valve mechanism 34 is changed over from the output force maintaining condition to the output force increasing condition.

With the change to the output force increasing condition, atmospheric air is introduced to the second variable pressure chamber 26. Further, the atmospheric air is introduced from the second variable pressure chamber 26 to the first variable pressure chamber 24, wherein the pressure in both chambers 24, 26 is increased. A forward force is thus applied to the movable wall 17 by the pressure difference between the first constant pressure chamber 23 and the first variable pressure chamber 24. A forward force is also applied to the movable wall 20 by the pressure difference between the second constant pressure chamber 25 and the second variable pressure chamber 26. Further, a forward force is applied to the power piston 22 by the pressure difference between the first constant pressure chamber 23 and the second variable pressure chamber 26. The entirety of the above-described forwarding forces is transmitted to the output rod 49 via the power piston 22, the stationary core 44 and the reaction disc 48. Both movable walls 17, 20, the power piston 22 and the output rod 49 are integrally moved forward relative to the housing 14, whereby the operation of the master cylinder is activated by the forward movement of the output rod 49 which is functionally connected to the master cylinder piston.

Under the above condition, the power piston 22 is also moved relative to the input member 28. Therefore, the atmospheric sealing portion 35a approaches the air vale seat 28a. The reaction disc 48 is compressed and deformed by the forward movement of the power piston 22 and the output rod 49 and retracts in the rearward direction. That is, the reaction disc 48 expands into the center hole of the guiding member 46. The rearward expansion of the reaction disc 48 serves to compensate for the clearance between the reaction disc 48 and the second transmitting member 52 generated by the separation of the air valve seat 28a from the atmospheric sealing portion 35a.

According to the forward movement of the power piston 22 relative to the input member 28, the atmospheric sealing portion 35a comes in contact with the air valve seat 28a, wherein the communication between the air passage 38 and the atmospheric air is interrupted. Therefore, air flow into both chambers 24, 26 is stopped, and the valve mechanism 34 is changed over from the output force increasing condition to the output force maintaining condition.

The self-braking operation or the automatic braking operation according to the first embodiment of the present invention is described below with the solenoid 41 (i.e., the actuator) being activated.

When the solenoid coil 42 is electrically controlled by the electronic control unit, the electromagnetic attraction force is generated between the movable core 45 and the stationary core 44. Accordingly, the movable core 45 and the plunger 61 are moved forward relative to the power piston 22 and the input member 28 against the biasing force of the valve spring 91. Corresponding to this forward movement of the movable core 45 and the plunger 61, the second transmitting member 52 engaged with the inward flange portion of the movable core 45 via the third transmitting member 53 is moved forward relative to the power piston 22 and the input member 28. Due to the forward movement of the movable core 45, the plunger 61, and the second transmitting member 52 by a predetermined distance, the front end portion of the second transmitting member 52 comes in contact with the rear surface of the reaction disc 48. The third transmitting member 53 disposed between the second transmitting member 52 and the movable core 45 is elastically deformable back and forth. Therefore, after the contact of the reaction disc 48 with the second transmitting member 52, the movable core 45 and the plunger 6 are further moved in the forward direction. Corresponding to the forward movement of the plunger 61, the negative pressure sealing portion 35b comes in contact with the negative pressure valve seat 22b, wherein the negative pressure valve V2 is closed. Therefore, the valve mechanism 34 establishes the output force maintaining condition. Further, the air valve seat 28a is separated from the atmospheric sealing portion 35a, wherein the air pressure valve V1 is opened. Therefore, the valve mechanism 34 establishes the output force increasing condition.

By establishing the output force increasing condition of the valve mechanism 34, the forward directed force is applied to the power piston 22 and the movables walls 17, 20, wherein the power piston 22 is moved forward relative to the housing 14. Corresponding to the forward movement of the power piston 22, the reaction disc 48 is compressed and deformed by the power piston 22 and the output rod 49 and is expanded in the rearward direction. The second transmitting member 52, the third transmitting member 53, the movable core 45, and the plunger 61 receive the reaction force corresponding to the output force of the output rod 49 and are thus retracted in the rearward direction. By virtue of the retraction of the second transmitting member 52, the third transmitting member 53, the movable core 45 and the plunger 61, the valve mechanism 34 is changed over from the output force increasing condition to the output force maintaining condition. The projecting amount of the reaction disc 48 is equal to the distance between the air valve seat 28a and the atmospheric sealing portion 35a.

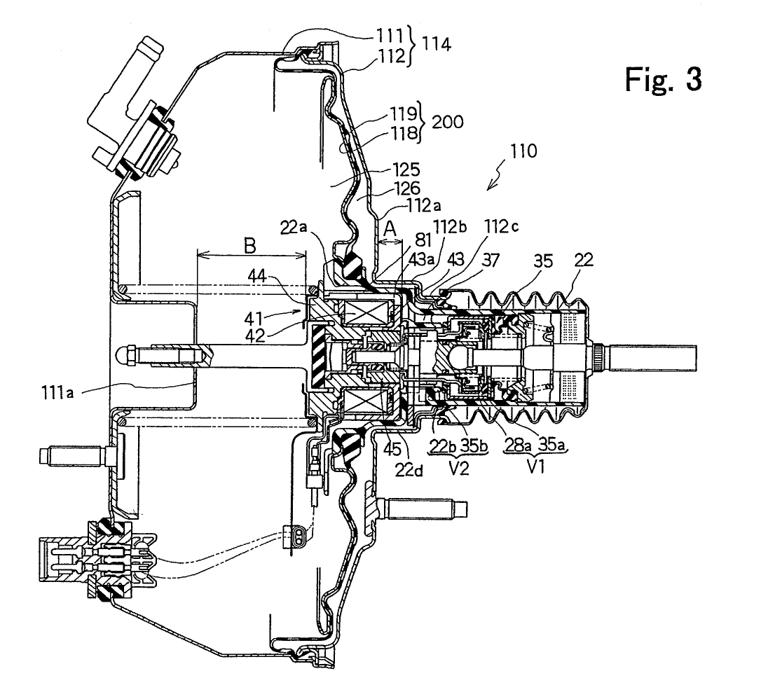

Referring to FIG. 3, a vacuum servo unit 110 (a single type vacuum servo unit) according to a second embodiment of the present invention possesses substantially the same structure as the vacuum servo unit 10 according to the first embodiment, except with respect to the position of the solenoid 41 relative to the housing 114 and with respect to a single pressure chamber being defined in the housing 114. Therefore, a detailed description of all of the features and functions associated with the second embodiment that are the same as those associated with the first embodiment will not be repeated. The description below discusses features and functions of the second embodiment that differ from those associated with the first embodiment.

As shown in FIG. 3, single pressure chamber in the housing 114 is divided into a constant pressure chamber 125 and a variable pressure chamber 126. A movable wall 200 is disposed in the housing 114 and is movable in the forward and rearward directions (i.e., in the left and right directions in FIG. 3). An actuator in the form of the solenoid 41 is accommodated in the cylindrical portion 22a at a front side of the power piston 22. The solenoid 41 is formed from the solenoid coil 42, the electromagnetic yoke 43, the electromagnetic stationary core 44, and the electromagnetic movable core 45.

A notch 43a (i.e., a concave or recessed portion) is defined at two portions at the outer periphery of the yoke 43 and extend to the rear end surface of the yoke 43. A communicating passage 81 is defined via the notch 43a and an inner surface of the cylindrical portion 22a, and serves with the vacuum passage 37 for connecting the constant pressure chamber 125 with the variable pressure chamber 126.

As described above, the communicating passage 81 is defined via the notch 43a and the inner surface of the cylindrical portion 22a. Therefore, there is no need to define an axially extending communicating passage integrally with the cylindrical portion 22a for connecting the constant pressure chamber 125 with the variable pressure chamber 126.

By virtue of the above-described structure according to the second embodiment of the present invention, a radial length or dimension of a stepped portion 22d of the cylindrical portion 22a can be reduced to a significant extent and preferably as much as possible. A projecting portion 112b serves to accommodate the solenoid 41 and the stepped portion 22d of the cylindrical portion 22a. Therefore, even if the solenoid 41 is accommodated at the rear side relative to the housing 14 by a length A so that the rear end portion of the solenoid 41 is disposed behind a vehicle clamp surface 112a of the housing 112, a radial length or dimension of the projecting portion 112b can be reduced to a significant extent and preferably as much as possible. Accordingly, a surface 111a to accommodate the master cylinder can be moved in the rearward direction by the length A, while maintaining a length B of the vacuum servo unit 110.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vacuum servo unit comprising:
a housing;
a movable wall dividing an inner space of the housing into a constant pressure chamber communicating with a negative pressure source and a variable pressure chamber selectively communicating with the negative pressure source or atmosphere;
a power piston connected to the movable wall;
an output member for outputting a forward moving force of the power piston in response to movement the movable wall;
an input member disposed in the power piston and movable in forward and rearward directions relative to the power piston by operation of a brake operating member;
a plunger movable in the forward and rearward directions relative to the input member and being movable in the forward and rearward directions in response to movement of the input member;
a valve mechanism for establishing or interrupting communication between the variable pressure chamber and atmosphere corresponding to movement of the plunger and for establishing or interrupting communication between the constant pressure chamber and the variable pressure chamber;
an actuator disposed in the power piston for moving the plunger in forward and rearward directions; and
a recessed portion defined at an outer periphery of the actuator and serving as a communicating passage between the constant pressure chamber and the variable pressure chamber.

2. The vacuum servo unit according to claim 1, wherein the actuator is a solenoid, the concave portion is a notch defined in a yoke enclosing the solenoid, and the communicating passage being formed by the notch and an inner periphery of a cylindrical portion of the power piston at a front side of the power piston.

3. The vacuum servo unit according to claim 2, wherein the communicating passage is formed as a through hole defined at the cylindrical portion of the power piston and the notch.

4. The vacuum servo unit according to claim 1, wherein a rear end portion of the actuator is disposed rearwardly of a vehicle clamp surface of the housing.

5. The vacuum servo unit according to claim 1, wherein the movable wall is a front side movable wall, the constant pressure chamber is a front constant pressure chamber and the variable pressure chamber is a front variable pressure chamber, and including a rear side movable wall disposed in the inner space of the housing to form a rear constant pressure chamber and rear variable pressure chamber.

6. A vacuum servo unit comprising:
a housing;
a movable wall dividing an inner space of the housing into a constant pressure chamber communicating with a negative pressure source and a variable pressure chamber selectively communicating with the negative pressure source or atmosphere;
a power piston connected to the movable wall;
an output member for outputting a forward moving force of the power piston in response to the movement the movable wall;
an input member disposed in the power piston and movable in forward and rearward directions relative to the power piston by operation of a brake operating member;
a plunger movable back and forth relative to the input member and being movable back and force in response to the movement of the input member;
a valve mechanism for establishing or interrupting communication between the variable pressure chamber and the atmosphere corresponding to the movement of the plunger and for establishing or interrupting communication between the constant pressure chamber and the variable pressure chamber;
an actuator disposed in the power piston for moving the plunger in the forward and rearward directions, the actuator including a yoke;
a lead wire electrically connecting the actuator with an electronic control unit; and
a notch defined at an outer periphery of the yoke, with a connecting portion between the lead wire and the actuator being disposed in the notch.

7. The vacuum servo unit according to claim 6, wherein the actuator includes a solenoid coil.

8. The vacuum servo unit according to claim 6, wherein the actuator includes a movable core that i s moved in response to energization of the solenoid coil.

9. The vacuum servo unit according to claim 6, wherein the movable wall is a front side movable wall, the constant pressure chamber is a front constant pressure chamber and the variable pressure chamber is a front variable pressure chamber, and including a rear side movable wall disposed in the inner space of the housing to form a rear constant pressure chamber and rear variable pressure chamber.

10. A vacuum servo unit comprising:
a housing;
a movable wall dividing an inner space of the housing into a constant pressure chamber communicating with a negative pressure source and a variable pressure chamber selectively communicating with the negative pressure source or atmosphere;
a power piston connected to the movable wall;
an output member for outputting a forward moving force of the power piston in response to movement the movable wall;
an input member disposed in the power piston and movable in forward and rearward directions relative to the power piston by operation of a brake operating member;
a plunger movable in the forward and rearward directions relative to the input member and being movable in the forward and rearward directions in response to movement of the input member;
a valve mechanism for establishing or interrupting communication between the variable pressure chamber and atmosphere corresponding to movement of the plunger and for establishing or interrupting communication between the constant pressure chamber and the variable pressure chamber;
a solenoid coil, a magnetic movable core and a magnetic yoke disposed in the power piston, the movable core being moved in response to energization of the solenoid coil and being operatively connected to the plunger to move the plunger in forward and rearward directions upon energization of the solenoid coil; and
the magnetic yoke having an outer periphery provided with at least one notch forming part of a passage communicating the constant pressure chamber and the variable pressure chamber.

11. The vacuum servo unit according to claim 10, wherein the power piston includes a cylindrical portion provided with a through hole forming a part of the communicating passage.

12. The vacuum servo unit according to claim 10, wherein the outer periphery of the magnetic yoke is provided with a pair of notches forming part of the communicating passage.

13. The vacuum servo unit according to claim 10, wherein a rear end portion of the yoke is disposed rearwardly of a vehicle clamp surface of the housing.

14. The vacuum servo unit according to claim 10, wherein the movable wall is a front side movable wall, the constant pressure chamber is a front constant pressure chamber and the variable pressure chamber is a front variable pressure chamber, and including a rear side movable wall disposed in the inner space of the housing to form a rear constant pressure chamber and rear variable pressure chamber.

15. The vacuum servo unit according to claim 10, wherein the at least one notch is a first notch, and including a second notch formed in an outer periphery of the magnetic yoke, and including a lead wire and terminal connected to the solenoid coil, the lead wire and the terminal portion being disposed in the second notch.

16. The vacuum servo unit according to claim 15, wherein the first notch opens to a rear end of the magnetic yoke and the second notch opens to a front end of the magnetic yoke.

17. The vacuum servo unit according to claim 15, including a pair of first notches forming part of the passage communicating the constant pressure chamber and the variable pressure chamber.
